(19) United States
(12) Patent Application Publication
(10) Pub. No.: US 2011/0315262 A1
(43) Pub. Date: Dec. 29, 2011

(54) SYSTEM AND METHOD FOR COMMUNICATION BETWEEN FILTERS AND FAUCETS

(76) Inventors: Andy Butler, Palo Alto, CA (US); Jeffrey B. Godfrey, Fairfield, CA (US); Todd Pope, Napa, CA (US)

(21) Appl. No.: 13/108,485

(22) Filed: May 16, 2011

Related U.S. Application Data
(60) Provisional application No. 61/334,963, filed on May 14, 2010.
(60) Provisional application No. 61/371,601, filed on Aug. 6, 2010.

(51) Int. Cl. F16L 11/00

(52) U.S. Cl. 138/109

(57) ABSTRACT

A system and method for connectors, piping systems, hoses, conduits, etc., to provide additional functionality beyond just watertight connectivity without their respective installations becoming cumbersome. In addition, current and future water faucet and water treatment/filtration systems need connection and actuation methods that provide additional functionality, and are simple in construction and easily installable.

### RELATED APPLICATIONS

This application claims priority from U.S. provisional application No. 61/334,963 filed on May 14, 2010 and U.S. Provisional application No. 61/371,601 filed on Aug. 6, 2010 which are incorporated by reference herein in their entirety

### FIELD OF THE INVENTION

The invention relates to the field of plumbing connectors and more particularly connections and conduits between faucets and water filtration devices that enable the communication of performance status of the filtration device to a recognizable signal element in a faucet.

### BACKGROUND OF THE INVENTION

Conventional faucets and water filtration systems are connected to plumbed-in water supplies and to one another by means of a variety of commonly available hoses, connectors, fittings and the like. Despite relative standardization in these elements, a wide variety of types, sizes, shapes and materials of such connectors makes it difficult to adapt add-on products such as accessory faucets and water filtering devices for easy installation to existing plumbing. Further, the difficulty of installation can increase due to a need for common household tools or even special trade tools to make certain an adequate, watertight connection has been achieved. In addition, current and future water faucet and water treatment/filtration systems need connection and actuation methods that provide additional functionality, are simple in construction and easily installable.

### SUMMARY OF THE INVENTION

A computer based system and method for connecting end user faucets with treated water from water treatment/filtration systems or untreated building water, by using a system of integrated multimodal conduits and/or junction box(es) to simplify needed connections, prevent assembly/installation errors, and provide a framework for new and/or increased features/functions. An embodiment includes a multi-conduit piping system having a device having multiple conduits including a first conduit of said multiple conduits capable of transporting a liquid without leaking the liquid, and a second conduit of the multiple conduits capable of transporting communication signals, and a device connector for coupling two devices, having an orientation guide to ensure proper fitting of the conduits in the two devices.

### BRIEF DESCRIPTION OF THE DRAWINGS

FIG. 1 is an illustration of multi-conduit systems in accordance with embodiments of the present invention.

FIG. 2 is an illustration of a general system configuration an embodiment showing the system elements in accordance with an embodiment of the invention.

FIG. 3 is an illustration of a faucet assembly and water treatment system in accordance with one embodiment.

FIG. 4 is an illustration of a faucet assembly, junction box and water treatment system in accordance with one embodiment.

FIG. 5 is an illustration of a faucet valve, junction box and water treatment system in accordance with one embodiment.

FIG. 6 is an illustration of various embodiments of quick-coupling connectors between input and output plumbing hoses having multiple pathways.

FIG. 7 is a figure of the environment in which the invention operates in accordance with an embodiment of the present invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

A preferred embodiment of the present invention is now described. Reference in the specification to “one embodiment” or to “an embodiment” means that a particular feature, structure, or characteristic described in connection with the embodiments is included in at least one embodiment of the invention. The appearances of the phrase “in one embodiment” or “an embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems. The invention can also be in a computer program product which can be executed on a computing system.

The present invention also relates to an apparatus for performing the operations herein. This apparatus may be specially constructed for the purposes, e.g., a specific computer, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

Conventional faucets and water filtration systems are connected to plumbed-in water supplies and to one another by means of a variety of commonly available hoses, connectors, fittings and the like. Despite relative standardization in these elements, a wide variety of types, sizes, shapes and materials of such connectors makes it difficult to adapt add-on products such as accessory faucets and water filtering devices for easy installation to existing plumbing. Further, the difficulty of installation can increase due to a need for common household tools or even special trade tools to make certain an adequate, watertight connection has been achieved. In addition, typical connectors are limited in purpose to the attachment of one water conveying element to another. In a direct connection between plumbing elements and an accessory such as a faucet or plumbed-in water filtering device, there is little if any need for anything other than watertight coupling for purposes of water conveyance between discrete plumbing elements and accessories. However, as water dispensing apparatus and water treatment and filtering devices become increasingly common, sophisticated and interconnected, there is a need to provide a means for connectors, piping systems, hoses, conduits, etc., to provide additional functionality beyond just watertight connectivity without their respective installations becoming cumbersome. In addition, current and future water faucet and water treatment/filtration systems need connection and actuation methods that provide additional functionality, and are simple in construction and easily installable.

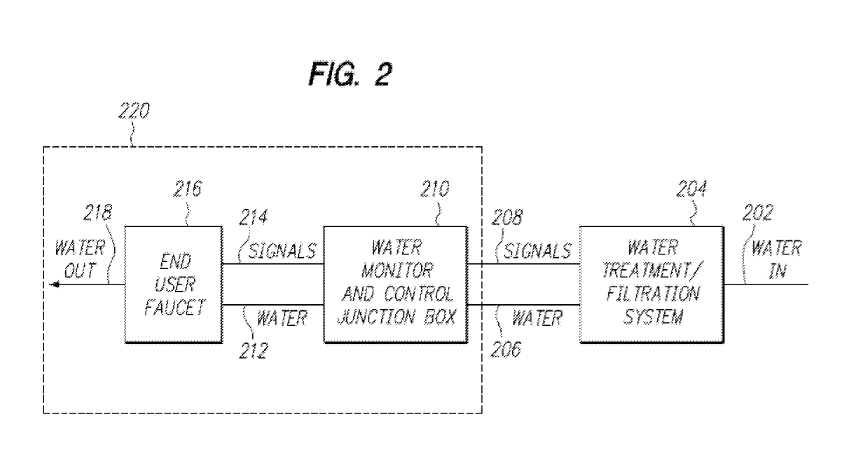

FIG. 2 shows the general environment of the system of this invention. The water 202 enters the system for municipal water of the building. There is a water treatment/filtration system 204 that can process water and send it through water pathway 206. The system 204 can also send and receive electrical and/or optical signals through the signals pathway 208. The end user faucet 216 receives water via a water pathway 212 and receives signals via a signals pathway 214 as they pass through a water monitor module (junction box) 210. The water exits to the end user through the water out location 218, and the set of components 220, consisting of the water monitor module/junction box 210, the end user faucet 216, and its associated components can be repeated in other locations in a building and/or residence.

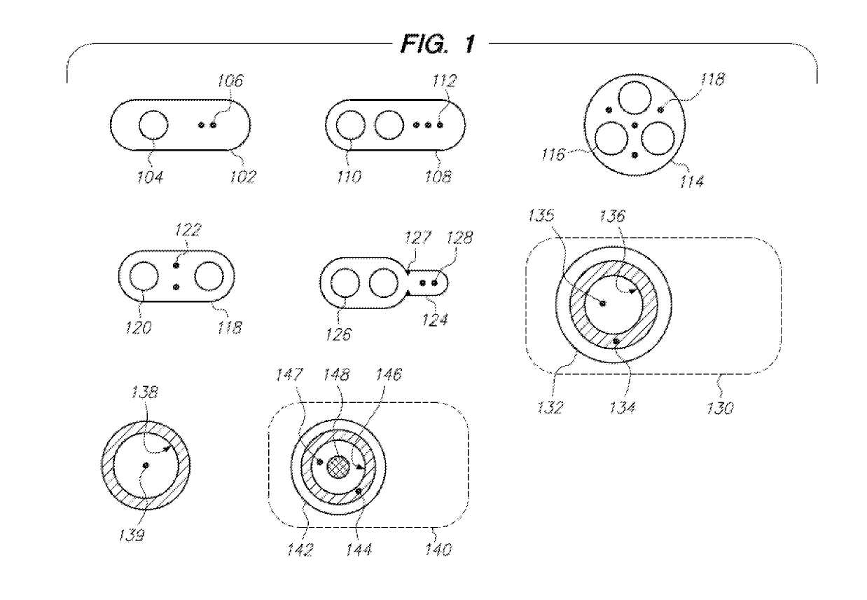

FIG. 1 is an illustration of multi-conduit systems in accordance with embodiments of the present invention. In an embodiment, a feature of the present invention is the combination, in a single conduit/system 102, of a watertight connector 104 with a separate means of electrical, light pipe or other fiber-optic communication 106 within or about the same connector and conduit system. In this embodiment, the function of the water pathway 206 and signals pathway 208 are combined into a single physical conduit 102. This also applies to water pathway 212 and signals pathway 214. This combination is beneficial for transmitting electrical signals and/or light signals 106, 208, 214 between a water treatment/filtering device 204, water monitor module/junctions box 210 and an end user faucet 216 such that a person using that faucet receives an identifiable and meaningful signal that indicates the level of performance of the water treatment system or other information. This electrical signal 106, 208, 214 can be employed to activate colored light emitting diodes (LEDs), liquid crystal displays (LCDs), lamps, or sound producing devices that are located somewhere in/on the faucet assembly to communicate or indicate a characteristic of the treatment or plumbing system, e.g., filter life, ultra-violet (UV) lamp life, need for maintenance, quality of the water being delivered to the faucet, etc. The optical signal can be used to illuminate a fiber optic light pipe or bundle that conveys this same performance status through a colored light that is carried in the water stream, or adjacent to or within the piping/hose elements. The electrical signal can be used to activate a pulsating stream of water delivered to the user as an indicator to the end user. Examples of mechanisms that can be used to create and/or control the pulsations include a solenoid valve, an electronically controlled pump, a valve controlled by a servo motor, piezo electric action, a pneumatic valve, a cam controlled or actuated pump, and a variable speed paddle wheel that can be electronically controlled. Additional details regarding a pulsating indicator is set forth in U.S. patent application Ser. No. 13/098,157 titled “Filter Life Pulsating Indicator and Water Filter System and Method” filed Apr. 29, 2011 which is incorporated by reference herein in its entirety.

An additional embodiment has the same physical configuration 102 of the water 104 and electrical and/or light signal pathway 106 in the same combined conduit configuration. In this embodiment, the signals are used to pass control information from the end user at the faucet 216 to the water monitor and control/junction box 210. These signals 214 could be initiated by any number of means, including buttons, knobs, membrane switch pads, infrared and ultrasonic proximity sensors and the like. The end user would use these inputs to control the water monitor and control/junction box 210 to take actions, for example: turn the water on/off, set the flow rate of the water, set the desired temperature of the water, etc.

In another embodiment, the electrical and/or optical signal connections 214 could be used for bi-directional communications between the end user/faucet 216 and the water monitor and control/junction box 210.

There are numerous water, electrical and/or optical multi-conduit configurations that can be implemented to yield increased functionality and beneficial results. FIG. 1 shows an embodiment 102 that contains a water pathway 104 and electrical or optical pathways 106. Another conduit embodiment is shown in 108 with an arrangement of two water pathways 110 and three electrical or optical pathways 112. An embodiment that follows a mostly circular cross section is shown in 114 which includes three water pathways 116 and four electrical or optical pathways 118. Other embodiments include the configuration shown in multi-conduit device 118 with two water pathways 120 and two electrical or optical pathways 122 laid out in a compact design that utilizes voids in the natural shape of the water pathways in a similar method to 114. An embodiment 124 that places the water 126 and the electrical/optical signal pathways 128 a small distance apart from one another can also have the added feature of a groove 127 that could create a natural weakness at that location that could be used to separate the two functions to support special installation needs.

An embodiment shown in multi-conduit device 130 has unique features in one or more of the water pathways 132. The example water pathway 132 has an inner layer 134 that would be flexible, just as the other parts of the conduit 130, but also have the added feature that its inner surface 136 is reflective to light in the visible and/or ultraviolet spectrum. This reflective inner surface 136 could allow light to be transmitted from a location like the water monitor and control/junction a box 210 through the water stream using the combination of the water present in the pathway and the reflective walls. This transmission could be for visible light to be used as an indicator to the end user, or for ultraviolet light in the correct wavelength to provide germicidal effects in the water stream between a water treatment/filtering system 204 and water monitor and control/junction box 210 along pathway 206 and between the water monitor and control/junction box 210 and the end user faucet 216.

In an embodiment a first conduit can be for transporting a liquid, e.g., water and can enclose a second conduit that transports a communication signal. In alternative embodiments the second conduit can surround the first conduit.

In an embodiment, the reflective inner surface 138 surrounds the water pathway 212 and the water is located in the center diameter 139.

In an embodiment, the integrated conduit 140 can contain one or more water pathways 142, 206, 212 which are constructed with inner reflective flexible walls 144 which have an inner surface 146 that is reflective to visible and ultraviolet spectrum light. Region 147 is open as a water pathway and inside this region is a plastic fiber 148 for the transmission of visible and/or ultraviolet spectrum light from the either the water treatment/filtration system 204 to the water monitor and control/junction box 210 or between the water monitor and control/junction box 210 and the end user faucet 216.

In an embodiment, the water monitor and control/junction box 210 converts electrical signals 208 into light signals 214 using one or more conventional electro-optical converters, for example, to be used to illuminate translucent plastic located in the end user faucet 216.

In an embodiment, the optical signal path 214 is concentric and located inside the water pathway 212 to provide a visual indicator of colored and/or flashing light visible from the exiting water stream of the end user faucet 216.

In an embodiment, ultraviolet light travelling through the water pathway 135 is stopped from exiting at the opening of the end user faucet 216, to prevent user exposure, by changes in the internal pathway geometry to stop internal reflections.

In an embodiment, the water monitor and control/junction box 210 can have more than one input for the water in 206. Each input can be of a different plumbing fitting type to allow the water monitor and control/junction box 210 to easily be installed with various input fitting types. The unused inputs can have built in one way valves or can be supplied with plugs to be used for the unused inputs.

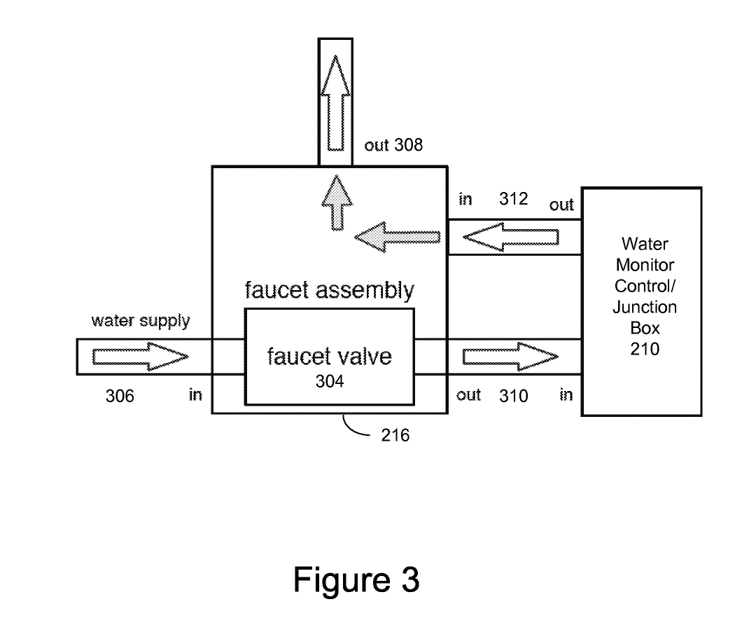

FIG. 3 is an illustration of a two-hose, inlet and outlet configuration between a water monitor and control/junction box 210 and the end user faucet 216 in accordance with one embodiment of the present invention. A water treatment/filtration system could be substituted for the water monitor and control/junction box 210, in an additional embodiment. A faucet assembly 216 receives a water supply from the building water or a water treatment/filtration system as its input 306. A valve 304 is capable of stopping or allowing water flow through the faucet valve 304. In another embodiment, the faucet valve 304 can be integrated in a faucet or can be positioned external to the faucet and exist in the water monitor and control/junction box 210. In another embodiment the faucet valve 304 can also include a switch or other device that can direct water flow directly to the output 308, that is, to bypass the water monitor and control/junction box 210 or the water treatment/filtration system in its place. If the valve is open the water proceeds to the water monitor and control/junction box 210 via conduit 310. Conduit 310 and/or conduit 312 is a multi-conduit of the type 102, 108, 114 etc, that combines water pathway and signal pathway. This embodiment enables a water shutoff valve 304 to be located “upstream” of the water monitor and control/junction box 210 or water treatment/filtration device (e.g., in the faucet) and further enables the device to function as a system for open discharge. An open discharge system configuration is when the faucet valve 304 is open the water in conduits 310, 312 and 308 flows from pressure it receives from water supply 306. There is nothing substantial to restrict the flow of water beyond (downstream) of the faucet valve 304. Once valve 304 is closed, the pressure is removed from the system downstream since it is open to discharge without restriction. In normal operating conditions water under household or municipal pressure flows through the device when the faucet valve 304 is open. When the faucet valve 304 is closed, incoming water 306 is prevented from reaching the water treatment/filtration device (or water monitor and control/junction box 210 and the remaining pressure from normal flow and system use is bled off or “vented”, since the water pathways are completely open without restrictions or valves, such that the pressure in the water monitor and control/junction box 210 or water treatment/filtration system in its place, goes to zero or approximately zero after and between each use. This configuration is shown as a configuration that an embodiment can support.

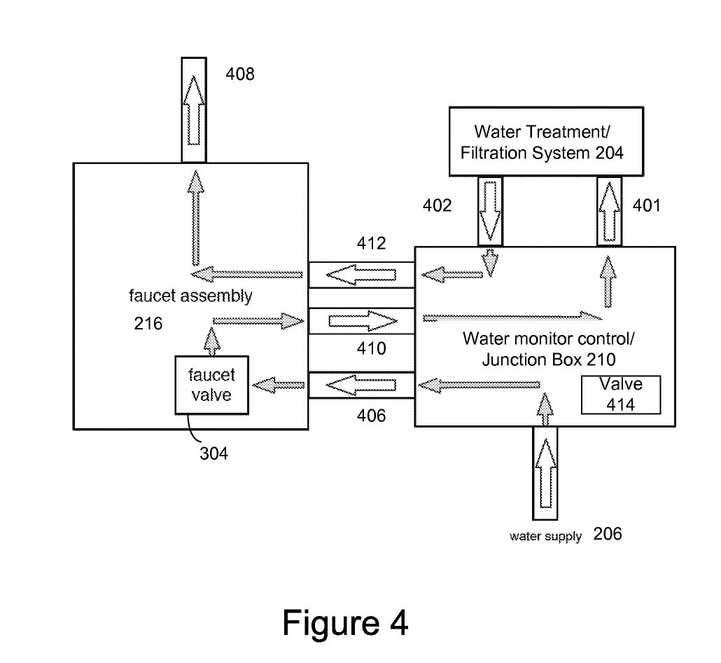

FIG. 4 is an illustration of one embodiment of the present invention, where a junction box is used as a universal gateway for all water and signal connections of the type 206, 208, 212, 214 between an end user faucet 216, water monitor and control/junction box 210, and a water treatment/filtration system 204. The Junction Box 210 in FIG. 4 houses connections for multi-conduit embodiments as in the type 102, 108, 114 etc and for non-multi-conduit connections one or more standard input fitting types, where water supply 206 enters the water monitor and control/junction box 210, can be included as discussed in a previous embodiment. In this embodiment, water pathway 406 and 410 can be multiconduit or can be standard water pathway plumbing tubing. Pathways 401, 402, 410 and 412 can be multconduit pathways with water and electrical/optical signals. In an embodiment, only pathways 402 and 412 are multiconduit pathways.

In an embodiment, the faucet valve 304 is moved to a different location, e.g., the position of valve 414. In this embodiment the signals in multiconduit 412 control the opening and closing of the valve 414. This embodiment also allows water treatment/filtration system 204 to control valve 414 through the signal pathway 401 or 402. This control allows the water treatment/filtration system 204 to stop water flow in the event of poor quality water or other situation that impacted the user. This action can signaled through signal pathway 401, 402, and 412 to alert the end user to the situation.

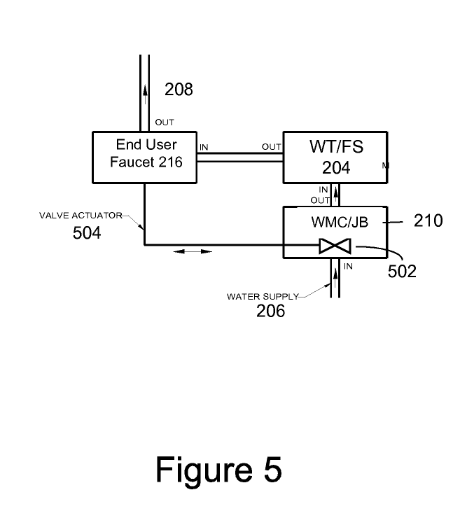

FIG. 5 is an illustration of an embodiment of the present invention where a valve 502 is located in the water monitor control/junction box 210. This valve 502 is actuated at the faucet 216 by a lever-cable mechanism, or by an electromechanical system comprising a switch, a communication link 504, (for example, 214 or 208, or a direct link using an electrical/optical connection (for example) that can be directly connected using a secondary lumen, described herein) and a solenoid valve or by some other means of providing communication between a linear or rotational displacement of a faucet element, or an on/off switching mechanism on the faucet, e.g., capacitive detectors that function through physical touch or proximity sensors, and the opening and closing of a valve that is located remotely from the faucet itself. This configuration utilizing and electronic or electromechanical system allows the valve to be controlled by the user faucet 216, through pathway 214, by the user, as well as being controlled by the water treatment/filtration system 204 through pathway 208, for a variety of uses. Two examples of uses for water treatment/filtration system control of the valve are to turn the valve off in a situation where unsafe water would be dispensed and to turn on the faucet to run the water while the building is unattended to prevent biofilm buildup in the plumbing system or to prevent water from freezing in the plumbing system and causing damage.

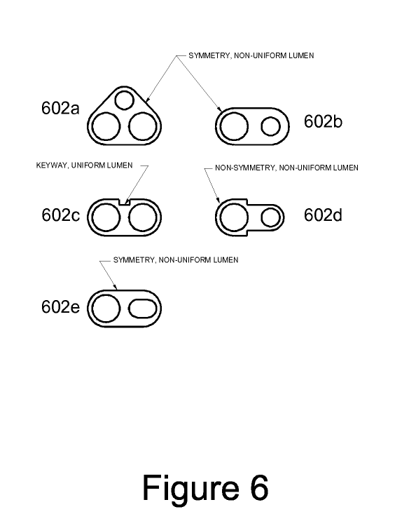

FIG. 6 is an illustration of various embodiments of multiconduit exterior shapes to be used for insuring that connections between plumbing devices can only be made one way (orientation) between input and output plumbing and signal conduits having multiple pathways. Another feature of the present invention includes having the inlet and outlet hoses between the faucet and water treatment system be connected together by means of a self-orienting quick-coupling mechanism (e.g., a unidirectional orientation guide/coupling such that the two mating elements can only be connected in one way). The coupling mechanism may include pathways for water only or it may include pathways for both water and some other means of communication, (e.g., an electrical wire or cable, a fiber optic bundle or light pipe, etc). A purpose of the self-orienting feature is to ensure that the hoses and communication elements emanating from the faucet can only be attached to the hoses and communication elements emanating from the water treatment system in one distinct orientation, thus ensuring ease of installation and proper outlet-to-inlet connection along lumens (fluid and other pathways). A number of common quick connect mechanisms can be incorporated into the present invention, including “John Guest” type quick compression couplers for hose fittings and plumbing elements, available for example from John Guest, Middlesex United Kingdom, for example, slip connect (SC), and quick-connect (QC). Electrical and optical connection examples include subminiature version A (SMA), subminiature version C (SMC) and straight tip (ST) quick optical connectors, for example, that preserve the fiber optic waveguide in fiber optic carries. There are a plurality of ways to achieve a single unique orientation for the connection, including but not limited to the individual application or combination of any of the following: (a) a keyway, pin, notch or other distinctive orienting feature in the opposing mating parts of the connector, e.g., lumen 602c; (b) a bayonet lock, the use of at least one diametrically different size for a lumen for a particular path, e.g., 602d; (c) the use of at least one different geometrical shape for a lumen, e.g., 602b, 602e; and (d) the use of an asymmetric or unidirectional geometry for the connector housing itself, e.g., 602a. The cross-sectional geometries depicted in FIG. 6 are illustrative examples and are not exhaustive of the possibilities for achieving the design and functionality of the present invention.

Alternatively, the geometrical cross sections depicted in FIG. 6 may be embodied in hose or tubing configurations that are co-extruded. Co-extrusion is a manufacturing process in which the complete cross section of the multiconduit system is created at the same time with a rubber or elastomic overmolded protective and insulting layer or otherwise combined during manufacturing to form multi-lumen conduits. The primary lumens of such multi-lumen elements typically form the conduits for conveyance of water. A secondary lumen, either integrally within the co-extrusion itself or affixed to the outside of the multi-lumen element or to the inside of one of the lumens, serves as a channel for carrying an electrical wire, fiber optic light pipe or fiber optic bundle, for example. This feature creates a communication modality between the water treatment/filtration system 204 and/or the water monitor control/junction box 210 and the end user faucet 216 and enables performance status information to be conveyed to a display on the faucet or to trigger another indicator, e.g., pulsating water, etc. Some examples of such indicators are described herein, that can be interpreted by a person using the faucet. The display may take the form of illumination of the water stream with different colors of light to indicate different levels of water treatment/filtration system 204 performance. For example a red water stream may indicate that the treatment module 204 is not on-line (water is not treated or is only being partially treated) or otherwise is not providing a minimum threshold of treatment, a yellow water stream may indicate that a portion of the treatment module 204, for example, needs replacement but is still providing a minimum level of performance. Alternatively, the display may be in the form of colored LEDs that are located within the faucet. These LEDs can either illuminate the water stream in different colors or simply provide some other type of physical illumination of an element of the faucet to indicate performance status of the water treatment device. The coupling mechanisms can then be either individual connectors that fit within the lumens of mating tubes or integrated members that fit over and/or around and form a watertight seal about the entire geometry.

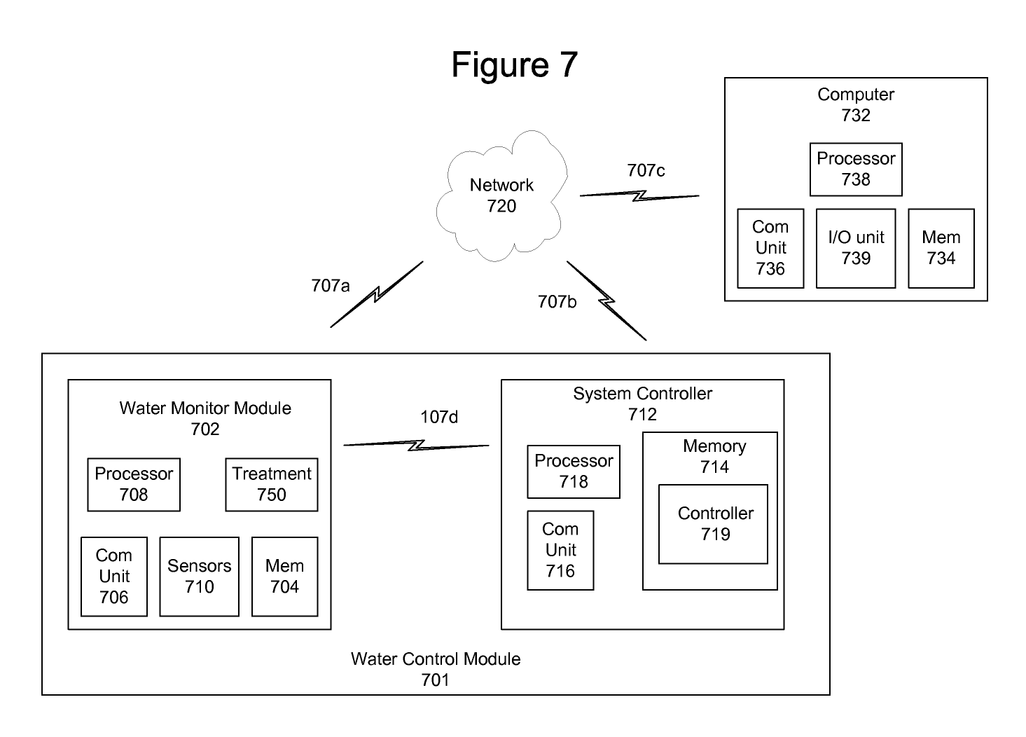

FIG. 7 is a figure of the environment in which the invention operates in accordance with an embodiment of the present invention. The operating environment may include a system controller 712 which can include a processor 718, a memory device 714 and a communications unit 716. The operating environment may include a communication link 707 for communications between the system controller 712, a network 720, a water monitor module 702 and/or a computer 732. The communication links described herein can directly or indirectly connect these devices (using communication units 706, 716 and/or 736, for example). Direct communication links can include electrical wire, optical wire, or other connections that can be connected between devices using, for example, a—lumen-type device, e.g., hose, pipe, which may use multi-lumen connectors, as described below. The network 720 can be, for example, a wireline or wireless communication network such as a WiFi, other wireless local area network (WLAN), a cellular network comprised of multiple base stations, controllers, and a core network that typically includes multiple switching entities and gateways. Other examples of the network 720 include the Internet, a public-switched telephone network (PSTN), a packet-switching network, a frame-relay network, a fiber-optic network, combinations thereof, and/or other types/combinations of networks. The combination of the Water Monitor module 702 and the system controller 712 is referred to as the Water Control Module 701.

Processors 708, 718 and/or 738 process data signals and may comprise various computing architectures including a complex instruction set computer (CISC) architecture, a reduced instruction set computer (RISC) architecture, or an architecture implementing a combination of instruction sets. Although only a single processor is shown in FIG. 7, multiple processors may be included. The processors can comprise an arithmetic logic unit, a microprocessor, a general purpose computer, or some other information appliance equipped to transmit, receive and process electronic data signals from the memory 704, 714, 734 and other devices both shown and not shown in the figures.

The computer 732 can be any computing device capable of executing computer modules/code for the functions described herein. For example, the computer can be a personal computer (PC) running on a Windows operating system that is commercially available from Microsoft Corp, Redmond, Wash., a computer running the Mac OS (and variations of) that is commercially available from Apple Computer, Inc., Cupertino, Calif., or other operating systems, a personal device assistant (PDA), a smart phone, e.g., an iPhone, commercially available from Apple Computer Inc. or a phone running the Android operating system, commercially available from Google, Inc, Mountain View, Calif. Other examples include a smart-watch, at tablet computer, e.g., the iPad (commercially available from Apple Computer, Inc) or any other device that can communicate with a network. For ease of discussion, the computer 732 will be described as a personal computer. The computer 732 includes a processor 738, as described above, a communication unit 736 for communicating with the network 720 (for example), a memory module 734, such as the memory modules described herein and an input/output unit 739 that can include input devices, e.g., keyboard, touch screen, mouse and output devices, e.g., a display.

The memory modules 704, 714 and/or 734 can be volatile and/or non-volatile memory, e.g., the memory may be a storage device such as a non-transitory computer-readable storage medium such as a hard drive, compact disk read-only memory (CD-ROM), DVD, or a solid-state memory device. The memory 704/714/734 can be physically part of the water monitor module 702, the system controller 712 and/or the computer 732 or can be remote from them, e.g., communicatively coupled to the water monitor module 702, the system controller 712 and/or the computer 732 via a wired/wireless connection 707, via a local area network (LAN), via a wide area network (WAN), via the Network 720, directly connected, etc.. For ease of discussion the memory 704/714/734 is described herein as being part of the water monitor module 702/system controller 712/computer 732.

Water monitor module 702 can include sensors 770 such as a flow sensor, temperature sensor (of water and/or air), pressure sensor, turbidity sensor, water impurities/components/particulates sensor, e.g., to measure lead, chlorine, etc, strain gauges, and/or other sensors to monitor levels or one or more consumables (e.g., salt in a system that has the function to soften water). Examples of a water flow sensor include a propeller/turbine meter, differential pressure meter, vortex meter, ultrasonic meter, rotameter, or any other flow meter type. The system may also have sensors that monitor the condition of system elements such as a sacrificial zinc electrode. Water monitor module 702 can also include a treatment module 750. The treatment module can include filters and/or other water treatment measures/devices. A variety of treatment methods can be employed by the water treatment module 750 in the water monitor module 702, including but not limited to ultra-violet (UV) light, ozonation, distillation, absorption media, ion-exchange media, membrane separation, chemical disinfection, and the like.

System controller 712 includes a processor 718, a communication unit 716 and a memory module that can include a controller 719. As described herein, the controller can be a program to determine how to control plumbing elements, e.g., valves, treatment module 750, sensors 770, etc.

A system 702 can include processors and/or computers, e.g., 712, 210 or processors 708, 718 and/or 738, can be used to generate signals that can be used to control the display described above. The system 701 can be part of or connected to the junction box 210 for example. In an embodiment the system 701 receives information from the Water Treatment module 750 and generates a signal that can be used to generate the display. As described above, the display can be in the form of LED, and/or fiber optics, for example, that, when controlled by the processor/computer displays an identifiable and meaningful signal indicating the level of performance of the water treatment system for example.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A multi-conduit piping system including:
a device having multiple conduits including a first conduit of said multiple conduits capable of transporting a liquid without leaking said liquid, and a second conduit of said multiple conduits capable of transporting communication signals; and
a device connector for coupling two devices, having an orientation guide to ensure proper fitting of said conduits in said two devices.

2. The system of claim 1 further comprising:
a control system for generating control signals, to be transmitted in said second conduit.

3. The system of claim 2, further comprising:
a liquid treatment device, for providing at least one of filtering and ultra-violet radiation treatment to said liquid, said liquid treatment device communicatively coupled to said control system.

4. The system of claim 1, wherein said second conduit is positioned within said first conduit.

5. The system of claim 1, wherein said first conduit is positioned within said second conduit.

6. The system of claim 1, wherein said first conduit includes a surface that is reflective to signals having a first range of frequencies.

7. The system of claim 6, wherein said first range of frequencies includes visible light and ultra-violet light.

8. The system of claim 6, further comprising:
a signal generator, for generating first signals in said first range of frequencies and directing said first signals into the liquid conduit.

9. The system of claim 8, wherein said first signals performs germicidal disinfecting on said liquid.

10. The system of claim 8, wherein said first signals are in the visible light frequency range and provide a color to the water that is visible to a user.

11. The system of claim 8 further comprising:
a control system for generating control signals, to be transmitted in said second conduit.

12. The system of claim 11, wherein said control system comprises said signal generator.
